(19) United States
(12) Patent Application Publication
(10) Pub. No.: US 2024/0125991 A1
(43) Pub. Date: Apr. 18, 2024

(54) TRANSMISSIVE WAVELENGTH TUNABLE HYPERSPECTRAL FILTER USING LAYERED TWISTED LIQUID CRYSTAL THIN FILM

(71) Applicants: POSTECH Research and Business Development Foundation, Pohang-si (KR); KOREA RESEARCH INSTITUTE OF CHEMICAL TECHNOLOGY, Daejeon (KR)

(72) Inventors: Young-Ki Kim, Pohang-si (KR); Jun-Hyung Im, Pohang-si (KR); Yeongseon Choi, Pohang-si (KR); Bogyu Lim, Daejeon (KR); Yejin Kim, Daejeon (KR); Seungju Jeon, Daejeon (KR); Kwang Hun Park, Daejeon (KR)

(21) Appl. No.: 18/378,233

(22) Filed: Oct. 10, 2023

(30) Foreign Application Priority Data
Oct. 14, 2022 (KR) 10-2022-0132158

(51) Int. Cl. G02B 5/26

(52) U.S. Cl. CPC G02B 5/26

(57) ABSTRACT

Disclosed is a transmissive wavelength tunable hyperspectral filter using layered twisted liquid crystal thin film, wherein the transmissive wavelength tunable hyperspectral filter is formed by laminating two or more layered twisted liquid crystal thin films having different broadband reflection bandgaps, wherein each of the layered twisted liquid crystal thin films includes a twisted liquid crystal layer including a plurality of unit liquid crystal molecules, and formed by arranging twisted liquid crystal complexes defining a preset cone angle along the helical axis with respect to the helical axis, and includes a pseudo-layer formed by arranging a plurality of twisted liquid crystal layers in a lengthwise direction of the helical axis at a preset inter-layer pitch (P).

### CROSS-REFERENCE TO RELATED APPLICATIONS

This application claims priority under 35 U.S.C. § 119 to Korean Patent Application No. 10-2022-0132158 filed on Oct. 14, 2022, in the Korean Intellectual Property Office, the disclosures of which are incorporated by reference herein in their entireties.

### BACKGROUND

“The present disclosure is derived from a study conducted as a part of personal basic research of the Ministry of Science and ICT (detailed project number: RS-2023-00212739, research project name: Design of multifunctional micro-robot based on bacterial self-assembly: Pohang University of Science & Technology, and research period: 2023.03.01 to 2024.02.29).”

“The present disclosure is derived from a study conducted as a part of steam research of the Ministry of Science and ICT (detailed project number: 2022M3C1A3081312, research project name: Development of optical security platform for commercialization of smart anti-counterfeiting technologies: Pohang University of Science & Technology, and research period: 2023.03.01 to 2024.12.31).”

“The present disclosure is derived from a study conducted as a part of steam research of the Ministry of Science and ICT (detailed project number: RS-2023-00302586, research project name: Development of film/spray-based color changing hydrogen sensor and real time AI-monitoring system: Pohang University of Science & Technology, and research period: 2023.08.01 to 2023.12.31).”

Embodiments of the present disclosure described herein relate to a transmissive wavelength tunable hyperspectral filter using layered twisted liquid crystal thin film.

As autonomous driving vehicles begin to spread and the use rate and spread of non-contact sensors increase due to COVID-19 pandemic, the demand for image sensors is rapidly increasing, and thus, the technological development of image sensors to analyze more accurate and large amounts of information is required.

The image sensor can be largely divided into a spectral filter that separates the wavelength of a signal and a sensor unit that receives a signal, and in particular, in the case of the spectral filter, the United States, Japan, and Germany possess the corresponding original technologies and manufacturing technologies, and thus, the situation is that all of them are imported and assembled in Korea.

Therefore, it is essential to secure the source technology of the spectral filter and develop a new concept spectral filter technology to solve the problems of the existing spectral filter.

However, the above spectral filter has the following problems.

Spectral filters that are currently commercialized and used may be largely divided into three types: Linescan filters, acousto-optic tunable filters, and Lyot filters, and the most widely used Linescan filter has a fixed detectable wavelength per pixel, and thus a large number of pixels are required to analyze the entire spectral spectrum in the required area whereby there is a limit in performance improvement due to a limit in its physical size.

In addition, because wavelengths that are not necessary have to be analyzed due to the fixed optical filter, there is a limit in improving data processing speed.

An acousto-optic tunable filter is a tunable filter that may selectively transmit light of various wavelengths with one filter by changing a refractive index of a crystal through an acoustic wave generated by a piezoelectric transducer. However, it cannot analyze all of broadband wavelength region due to a small refractive index change of the crystal and has very high manufacturing costs.

A Lyot filter is a filter that selectively passes only light of a desired wavelength by laminating birefringent optical filters that pass light of a specific wavelength, and because it uses several (three or more) polarizers and optical filters, a transmittance of light is significantly reduced.

In particular, the existing spectral filter technology described above has a fixed transmission wavelength per pixel, and because a physical size of elements increases to implement a high-resolution image sensor, it acts as an obstacle to high integration and miniaturization of the image sensor, and thus, research for solving the problems are needed.

### SUMMARY

An aspect of the present disclosure provides a transmissive wavelength tunable hyperspectral filter using layered twisted liquid crystal thin film, which may selectively adjust a transmissive wavelength with one spectral filter including a layered twisted liquid crystal that is a new material.

According to an embodiment, there is provided a transmissive wavelength tunable hyperspectral filter using layered twisted liquid crystal thin film, wherein the transmissive wavelength tunable hyperspectral filter is formed by laminating two or more layered twisted liquid crystal thin films having different broadband reflection bandgaps, wherein each of the layered twisted liquid crystal thin films includes a twisted liquid crystal layer including a plurality of unit liquid crystal molecules, and formed by arranging twisted liquid crystal complexes defining a preset cone angle along the helical axis with respect to the helical axis, and a pseudo-layer formed by arranging a plurality of twisted liquid crystal layers in a lengthwise direction of the helical axis at a preset inter-layer pitch (P).

Furthermore, the layered twisted liquid crystal thin film selectively may reflects, among the incident lights, only light of a specific wavelength region through Bragg reflection, wherein the specific wavelength region is set based on an average refractive index (n̅) of the layered twisted liquid crystal thin film and an inter-layer pitch (P) of a twisted liquid crystal layer included in the corresponding layered twisted liquid crystal thin film to satisfy an equation below, and the inter-layer pitch (P) of the twisted liquid crystal layer may be determined by the cone angle of the twisted liquid crystal complex.

Furthermore, a broadband reflection bandgap of the layered twisted liquid crystal thin film may be shifted by a change in the inter-layer pitch of the twisted liquid crystal layer through application of external stimuli, and the layered twisted liquid crystal thin film may transmit only light of a wavelength region corresponding to the shifted broadband reflection bandgap.

Furthermore, the external stimulus may be any one stimulus selected from a group consisting of an electric field, temperature, moisture, bacteria, and light.

Furthermore, a liquid crystal thin film of any one layer of the two or more layered twisted liquid crystal thin films and a liquid crystal thin film of another layer thereof may have different shifted broadband reflection bandgaps when the external stimulus is applied.

Furthermore, the pseudo-layer may be formed by arranging a plurality of twisted liquid crystal layers arranged in an interior of the layered twisted liquid crystal thin film such that the plurality of twisted liquid crystal layers form an inter-layer pitch gradient.

Furthermore, the pseudo-layer may be formed by arranging a plurality of twisted liquid crystal layer composites including one or more twisted liquid crystal layers having the same inter-layer pitch such that the plurality of twisted liquid crystal layer composites form an inter-layer pitch gradient.

Furthermore, the layered twisted liquid crystal thin film may include a chiral dopant having a property of being diffused toward a side, on which ultraviolet rays are irradiated, a photopolymerizable polymer fixing the twisted liquid crystal complexes on the pseudo-layer through an ultraviolet ray curing reaction, and a concentration gradient in the chiral dopant in the layered twisted liquid crystal thin film may be formed as the chiral dopant is diffused toward the irradiated ultraviolet rays when the ultraviolet rays are irradiated to an upper end of the layered twisted liquid crystal thin film, and the layered twisted liquid crystal thin film may include a pseudo-layer formed as the plurality of twisted liquid crystal layers are arranged while forming an inter-layer pitch gradient by adjusting a concentration of the chiral dopant such that an inter-layer pitch of a twisted liquid crystal layer located on an upper portion of the layered twisted liquid crystal thin film becomes shorter and an inter-layer pitch of a twisted liquid crystal layer located at a lower portion thereof becomes longer according to the concentration gradient of the formed chiral dopant.

Furthermore, the layered twisted liquid crystal thin film may change the inter-layer pitch over the plurality of twisted liquid crystal layers by applying the electric field to the layered twisted liquid crystal thin film and changing the cone angle of the twisted liquid crystal complex, the layered twisted liquid crystal thin film may form a twisted liquid crystal layer composite including one or more twisted liquid crystal layers having the same inter-layer pitch by irradiating an ultraviolet ray to an upper end of the layered twisted liquid crystal thin film, forming a polymer network based on the photopolymerizable polymer, and stabilizing the twisted liquid crystal layer corresponding to a partial area of the layered twisted liquid crystal thin film, some of the plurality of twisted liquid crystal layers, other than the formed twisted liquid crystal layer composites, may be caused to return to have an initial inter-layer pitch by removing the applied electric field, and the layered twisted liquid crystal thin film may include a pseudo-layer formed by arranging the plurality of twisted liquid crystal layer composites while the plurality of twisted liquid crystal layer composites form an inter-layer pitch gradient, through a staged adjustment of electric fields, in which these processes are repeated.

### BRIEF DESCRIPTION OF THE FIGURES

The above and other objects and features of the present disclosure will become apparent by describing in detail embodiments thereof with reference to the accompanying drawings.

FIG. 1 is a conceptual view of a transmissive wavelength tunable hyperspectral filter using layered twisted liquid crystal thin film according to an embodiment of the present disclosure;

FIG. 2 is a view illustrating a diagram of a structure of layered twisted liquid crystal molecules in a layered twisted liquid crystal thin film according to an embodiment of the present disclosure;

FIGS. 3 and 4 are views illustrating a principle of adjusting a reflection wavelength by applying external stimuli to a transmissive wavelength tunable hyperspectral filter using layered twisted liquid crystal thin film according to an embodiment of the present disclosure;

FIG. 5 is a view illustrating a diagram of a structure of layered twisted liquid crystal molecules through adjustment of an intensity of an electric field according to an embodiment of the present disclosure;

FIG. 6 is a view illustrating a process of forming an inter-layer pitch gradient by adjusting a concentration of a chiral dopant in a layered twisted liquid crystal thin film according to an embodiment of the present disclosure;

FIG. 7 is a view illustrating a process of forming an inter-layer pitch gradient through a staged adjustment of electric fields of a layered twisted liquid crystal thin film according to another embodiment of the present disclosure;

FIG. 8 is a view illustrating a process of forming an inter-layer pitch gradient by adjusting a density of a polymer network of a layered twisted liquid crystal thin film according to another embodiment of the present disclosure;

FIG. 9 illustrates a precedent result for identifying formation of a broadband reflection bandgap of a layered twisted liquid crystal thin film according to a third embodiment;

FIG. 10 illustrates a precedent result of adjustment of a transmissive wavelength through adjustment of an intensity of an electric field in a transmissive wavelength tunable hyperspectral filter using layered twisted liquid crystal thin film according to a third embodiment; and

FIG. 11 is a precedent result of adjustment of a transmissive wavelength through adjustment of an intensity of an electric field in a transmissive wavelength tunable hyperspectral filter using layered twisted liquid crystal thin film according to a first embodiment.

### DETAILED DESCRIPTION

Hereinafter, detailed embodiments of the present disclosure will be described in detail with reference to the drawings.

In the description of the present disclosure, when it is determined that a detailed description of related known configurations or functions may make the essence of the present disclosure unclear, a detailed description thereof will be omitted.

Embodiments of the present disclosure are provided to explain the present disclosure to an ordinary person in the art, to which the present disclosure pertains, more fully, and the following embodiments may be modified into several other forms, and the scope of the present disclosure is not limited to the following embodiments.

Rather, the embodiments are provided to make the present disclosure more fully and perfectly, and deliver the spirits of the present disclosure to the ordinary person perfectly.

Furthermore, in the following drawings, the components are exaggerated for convenience of description and clarity, and the same reference numerals denote the same elements on the drawings. As used in the specification, the term “and/or” includes any one and one or more combinations of the listed items.

The terms used in the specification are used to describe specific embodiments, and are not intended to limit the present disclosure.

As used in the specification, a singular form may include a plural form unless it clearly indicates another case. Furthermore, when the terms, such as “comprise” and/or “comprising”, is used in the specification, they specify presence of the above-mentioned shapes, numbers, steps, operations, members, elements, and/or groups thereof, and do not exclude presence or addition of one or more other shapes, numbers, operations, members, elements, and/or groups thereof.

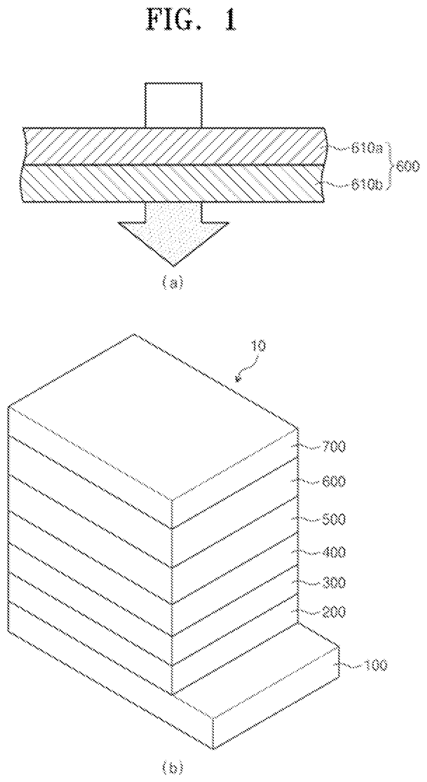

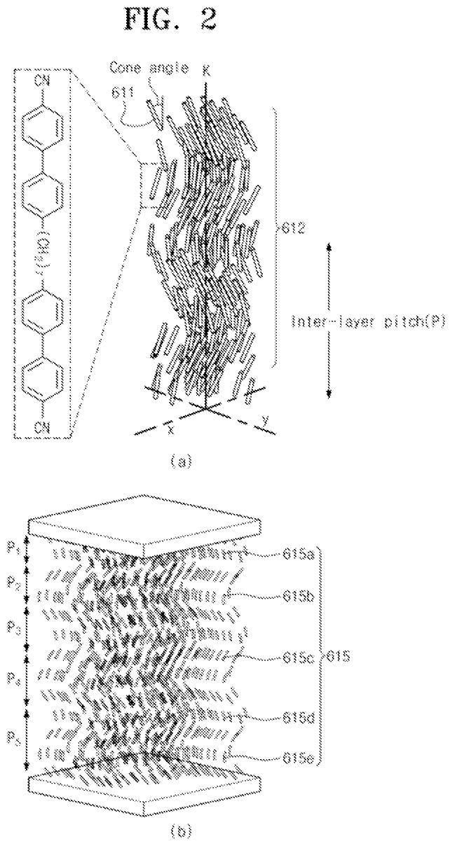

FIG. 1 is a conceptual view of a transmissive wavelength tunable hyperspectral filter using layered twisted liquid crystal thin film according to an embodiment of the present disclosure, and FIG. 2 is a view illustrating a diagram of a structure of layered twisted liquid crystal molecules in the layered twisted liquid crystal thin film according to the embodiment of the present disclosure.

FIG. 1A is a conceptual view of the transmissive wavelength tunable hyperspectral filter using a plurality of layered twisted liquid crystal thin films, and FIG. 1B is a conceptual view of an image sensor using a hyperspectral filter of FIG. 1A.

First, referring to FIG. 1, an image sensor 10 may include a substrate, a lower electrode layer 100, a charge blocking layer 200, a photoactive layer 300, a charging blocking layer 400, a lower electrode of liquid crystal filter and an upper electrode layer 500 of a photodiode, a transmissive wavelength tunable hyperspectral filter 600, and a transparent electrode 700.

Here, the transmissive wavelength tunable hyperspectral filter 600 reflects different wavelengths of light, respectively, and includes two or more layered twisted liquid crystal thin films 610.

In detail, the transmissive wavelength tunable hyperspectral filter 600 may be formed by laminating the two or more layered twisted liquid crystal thin films 610 having different broadband reflection bandgaps.

Then, the layered twisted liquid crystal thin film 610 has pseudo-layers that are regularly arranged in a two-dimensional or three-dimensional form, and a specific wavelength region, through which the incident light cannot pass due to a periodic inter-layer pitch “P” due to the pseudo-layers, is present, and this is called a reflection bandgap or a photonic bandgap.

In addition, the pseudo-layers are formed while the respective layers form an inter-layer pitch gradient as an electric field is applied or external stimuli are applied in a state, in which an electric field is applied, and here, the inter-layer pitches of the respective layers may be changed by applying an electric field.

The layered twisted liquid crystal thin film 610 according to an embodiment of the present disclosure includes a plurality of layered twisted structures that have twist and bend configurations in interiors thereof at the same time, and thus also may have a broadband reflection bandgap that may reflect a wide range of wavelength region only with one thin film.

According to the transmissive wavelength variable hyperspectral filter according to an embodiment, there is a limitation in that the number of manufacturing processes increases and it is difficult to obtain a high transmittance and narrow full width at half maximum (FWHM) of transmissive wavelength when three or more layered twisted liquid crystal thin films 610 are laminated, and thus, it is preferable that two layered twisted liquid crystal thin films 610a and 610b are laminated.

Furthermore, the transmissive wavelength tunable hyperspectral filter 600, as described above, is formed by laminating two or more layered twisted liquid crystal thin films 610 having different broadband reflection bandgaps, and thus the light of wavelength region, in which light is not reflected, may be selectively passed, and then, because the transmissive wavelength may be obtained by using a transmissive wavelength region, in which the reflection wavelength regions of the two or more layered twisted liquid crystal thin film 610 having different broadband reflection bandgaps do not overlap each other, FWHM of the transmissive wavelength may be implemented to be narrower than when one layered twisted liquid crystal thin film 610 is used.

Accordingly, the transmissive wavelength tunable hyperspectral filter 600 may separate a wavelength of a signal, and is laminated together with a sensor part that receives the signal to be implemented as the image sensor 10.

FIG. 2A is a view illustrating liquid crystal molecules included in a layered twisted liquid crystal thin film 610, and FIG. 2B is a view illustrating liquid crystal molecule layers included in the layered twisted liquid crystal thin film 610.

The layered twisted liquid crystal thin film 610 includes a plurality of unit liquid crystal molecules 611, and may include a twisted liquid crystal layer 615 that is formed by arranging a twisted liquid crystal complex 612 that define a preset cone angle along the helical axis “K” with respect to the helical axis “K”.

In addition, the cone angle defined by the twisted liquid crystal complex 612 and the helical axis “K” may be changed when an electric field is applied or external stimuli are applied in a state, in which an electric field is applied, and the inter-layer pitch of the twisted liquid crystal layer 615 is changed as the cone angle is changed.

That is, because the unit liquid crystal molecules 611 are arranged while defining a cone angle that deviates from the helical axis in an interior of the layered twisted liquid crystal thin film 610, the twisted liquid crystal complex 612 including the plurality of unit liquid crystal molecules 611 also is arranged while defining a preset cone angle with the helical axis, and the layered twisted liquid crystal thin film 610 may include a plurality of twisted liquid crystal layers 615a, 615b, 615c, 615d, and 615e that are formed while the preset cone angle of the twisted liquid crystal complex 612 with respect to the helical axis “K” is changed when external stimuli are applied in a situation, in which an electric field is applied.

In detail, as illustrated in FIG. 2A, the twisted liquid crystal complexes 612 including the plurality of unit liquid crystal molecules 611 have a spirally distorted form, and are continuously arranged while having a constant pitch to form the same structure layer. Then, a length of the same structure layer, in which the twisted liquid crystal complexes 612 are continuous, is referred to as the inter-layer pitch “P”, and has a property of selectively reflecting the incident light due to the continuous structure. The reflection wavelength region is determined by the inter-layer pitch “P”, and the respective layers may be arranged while having different inter-layer pitches through adjustment of a concentration of the chiral dopant or staged adjustment of electric fields.

In more detail, the inter-layer pitch is proportional to the cone angle of the twisted liquid crystal complex 612, and the inter-layer pitch becomes smaller as the cone angle decreases and the inter-layer pitch becomes larger as the cone angle increases.

Then, the unit liquid crystal molecules 611 are molecules that have more excellent bend characteristics than twist characteristics, and the unit liquid crystal molecules 611 are at least one material that is selected from a group of molecules, in which a plurality of hard mesogenic units are connected to each other by a flexible carbon chain.

The twisted liquid crystal complexes 612 may be formed by mixing a photopolymerizable polymer 614 with the unit liquid crystal molecules 611, and any material that has a liquid crystalline phase and may be polymerized may be used as the photopolymerizable polymer 614 without limitation.

In the transmissive wavelength tunable hyperspectral filter 600 using the layered twisted liquid crystal thin film according to an embodiment of the present disclosure, the unit liquid crystal molecule 611 preferably is 1″,7″-bis(4-cyanobiphenyl-4′-yl) heptane (CB7CB), and the photopolymerizable polymer 614 preferably is at least one material selected from a group consisting of reactive mesogen23, reactive mesogen82, reactive mesogen105, and reactive mesogen257.

Furthermore, in the transmissive wavelength tunable hyperspectral filter 600 using the layered twisted liquid crystal thin film according to an embodiment of the present disclosure, it is preferable that the twisted liquid crystal complexes 612 are oriented while defining a cone angle in a range of 15 to 40 degrees with respect to the helical axis “K”. The range of the cone angle is determined by a relative ratio of the twist and bend characteristics of the liquid crystal composite. Furthermore, the cone angle may be changed according to a change in the applied stimuli (an electric field, a temperature, or the like), and its range may be determined within a range of 0 to 90 degrees.

Furthermore, the layered twisted liquid crystal thin film 610 may include a pseudo-layer that is formed by arranging a plurality of twisted liquid crystal layers 615 in a lengthwise direction of the helical axis while the plurality of twisted liquid crystal layers 615 have a preset inter-layer pitch “P”.

In detail, in an embodiment of the present disclosure, the pseudo-layer may be formed by arranging the plurality of twisted liquid crystal layers arranged in the interior of the layered twisted liquid crystal thin film 610 while the plurality of twisted liquid crystal layers form an inter-layer pitch gradient.

In addition, in another embodiment of the present disclosure, the pseudo-layer may be formed by arranging the plurality of twisted liquid crystal layer composites including one or more twisted liquid crystal layers 615 having the same inter-layer pitches while the plurality of twisted liquid crystal layer composites form an inter-layer pitch gradient.

That is, because the plurality of twisted liquid crystal layers 615 arranged in the interior of the layered twisted liquid crystal thin film 610 are arranged while forming the inter-layer pitch gradient and, among the twisted liquid crystal layers 615, the one or more twisted liquid crystal layers 615 having the same interlayer pitch form a plurality of twisted liquid crystal layer composites, the plurality of twisted liquid crystal layer composites arranged in the interior of the layered twisted liquid crystal thin film 610 are arranged while forming the inter-layer pitch gradient.

Accordingly, the layered twisted liquid crystal thin film 610 may reflect wide range of the wavelength with one thin film when the light is input, due to the pseudo-layer having the inter-layer pitch gradient in the thin film.

In addition, because the plurality of twisted liquid crystal layers 615 in the layered twisted liquid crystal thin film 610 have stimuli-responsive characteristics, the inter-layer pitch may be precisely controlled through application of various external stimuli whereby a reflection wavelength may be adjusted precisely and promptly.

Referring to FIG. 2B, the layered twisted liquid crystal thin film 610 according to an embodiment of the present disclosure may be formed by laminating the plurality of twisted liquid crystal layers 615, and the respective twisted liquid crystal layers 615a, 615b, 615c, 615d, and 615e have different inter-layer pitches.

It is preferable that the inter-layer pitch of the twisted liquid crystal layers 615 according to an embodiment of the present disclosure has an inter-layer pitch that is preset to satisfy a range of 0.27 to 1.3 μm when the unit liquid crystal molecules 611 are CB7CB. Furthermore, the above range is not limited thereto, and may become different according to the kind of the unit liquid crystal molecules 611, a concentration of the chiral dopant 613, and the like.

It is preferable that the number of the plurality of twisted liquid crystal layers 615 according to an embodiment of the present disclosure are arranged to satisfy a range of 10 to 50.

Here, when ten or less twisted liquid crystal layers 615 are arranged, light of a specific wavelength is insufficiently reflected, and when more than fifty twisted liquid crystal layers 615 are arranged, the layers are not arranged in parallel to each other whereby the light may be scattered and a low reflectance may be caused.

The layered twisted liquid crystal thin film 610 may selectively reflects, among the incident lights, only light of a specific wavelength region through Bragg reflection, the specific wavelength region is set based on an average refractive index (n̅) of the layered twisted liquid crystal thin film 610 and the inter-layer pitch “P” of the twisted liquid crystal layers 615 included in the corresponding layered twisted liquid crystal thin film 610 to satisfy Equation 1 below, and the inter-layer pitch “P” of the twisted liquid crystal layers 615 is determined according to the cone angle of the twisted liquid crystal complex 612.

λ=n̅P Equation 1

Here, n is the average refractive index of the layered twisted liquid crystal thin film, and P is the inter-layer pitch of the twisted liquid crystal layers.

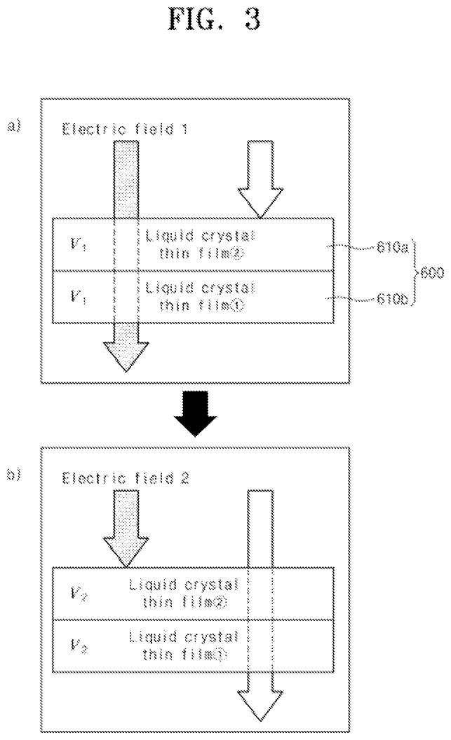

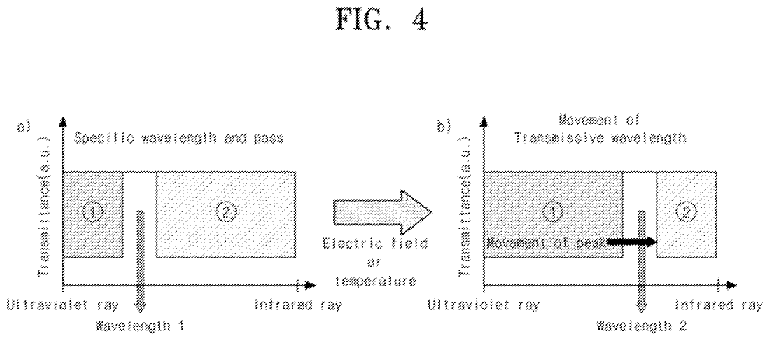

FIGS. 3 and 4 are views illustrating a principle of adjusting a reflection wavelength by applying external stimuli to the transmissive wavelength tunable hyperspectral filter using the layered twisted liquid crystal thin film according to an embodiment of the present disclosure.

FIG. 3A is a view illustrating a transmission area of a filter after a first electric field E₁ is applied, and FIG. 3B is a view illustrating a shifted transmission area of a filter after a second electric field E₂ is applied.

In detail, as illustrated in FIGS. 3A and 3B, a broadband reflection bandgap of the layered twisted liquid crystal thin film 610 is shifted according to a change in the inter-layer pitch of the twisted liquid crystal layer 615 through application of external stimuli, and transmits the light of the wavelength region corresponding to the shifted broadband reflection bandgap. Accordingly, the transmissive wavelength tunable hyperspectral filter using the layered twisted liquid crystal thin film according to an embodiment of the present disclosure may transmit lights of different wavelength regions under the first electric field and the second electric field.

Here, the external stimulus may be at least one stimulus selected from a group consisting of an electric field, temperature, moisture, bacteria, or light.

That is, when different electric fields are applied to the layered twisted liquid crystal thin film 610, the reflection area for the input light is shifted, and thus the transmission region of the incident light may be changed.

FIG. 4A is a view illustrating a reflection wavelength region band of a spectral filter in a state, in which the first electric field E₁ is applied, and FIG. 4B is a view illustrating a shifted reflection wavelength region band of the spectral filter in a state, in which the second electric field E₂ is applied.

Furthermore, referring to FIGS. 4A and 4B, it is preferable that two or more layered twisted liquid crystal thin films 610 are laminated, and, a liquid crystal thin film of any one layer of the two or more layered twisted liquid crystal thin films 610 and a liquid crystal thin film of another layer other than the any one layer may have different shifted broadband reflection bandgaps when the external stimulus is applied.

In detail, when two layered twisted liquid crystal thin films 610 may transmit light of a third region (wavelength 1), in which the first region and the second region do not overlap each other, the liquid crystal thin film of the any one layer reflects a first region that is a short wavelength region of the incident light and the liquid crystal thin film of the another layer other than the any one layer reflects a second region that is a long wavelength region of the incident light, in a state, in which the first electric field is applied.

Furthermore, when the second electric field, an intensity of which is lower than that of the first electric field is applied, and the liquid crystal thin film of the any one layer reflects a first region that is shifted toward a long wavelength in a state, in which the second electric field is applied and the liquid crystal thin film of the another layer other than the any one layer reflects a second region that is shifted toward a long wavelength region, the two layered twisted liquid crystal thin films 610 transmit light of a fourth region (wavelength 2), in which the shifted first region and the shifted second region do not overlap each other.

In other words, as the two or more layered twisted liquid crystal thin films 610 having different broadband reflection bands are laminated, the transmissive wavelength tunable hyperspectral filter 600 may transmit light corresponding to an area, in which broadband reflection bands of the liquid crystal thin film of the any one layer of the two or more layered twisted liquid crystal thin films 610 and the liquid crystal thin film of the another layer other than the any one layer do not overlap each other.

In addition, the transmissive wavelength tunable hyperspectral filter 600 may transmit the light corresponding to the region in which the shifted broadband reflection bands do not overlap each other, as the broadband reflection bands of the liquid crystal thin film of the any one layer of the two or more layered twisted liquid crystal thin films 610 and the liquid crystal thin film of the another layer other than the any one layer are shifted, respectively, when the external stimulus such as the electric field is applied.

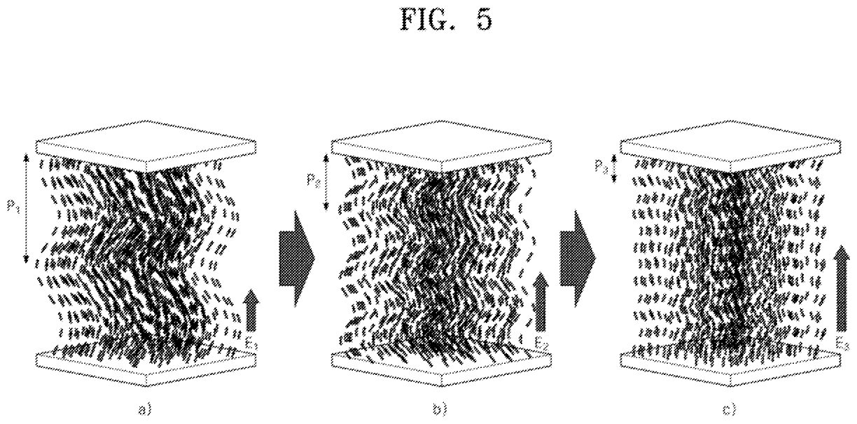

FIG. 5 is a view illustrating a diagram of a structure of layered twisted liquid crystal molecules through adjustment of an intensity of an electric field according to an embodiment of the present disclosure.

FIG. 5A is a view illustrating a change in a form of liquid crystal molecules when, among the external stimuli, a first electric field is applied to the layered twisted liquid crystal thin film, FIG. 5B is a view illustrating a change in a form of liquid crystal molecules when, among the external stimuli, a second electric field is applied to the layered twisted liquid crystal thin film, and FIG. 5C is a view illustrating a change in a form of liquid crystal molecules when, among the external stimuli, a third electric field is applied to the layered twisted liquid crystal thin film.

Referring to FIG. 5, in the transmissive wavelength tunable hyperspectral filter using the layered twisted liquid crystal thin film according to an embodiment of the present disclosure, the inter-layer pitch of the plurality of twisted liquid crystal layers 615 in the layered twisted liquid crystal thin film 610 may be changed according to the intensity of the applied electric field.

The layered twisted liquid crystal thin film 610 of FIG. 5 has a pseudo-layer that is formed by arranging the plurality of twisted liquid crystal layers 615 while having the same inter-layer pitch and with no inter-layer pitch gradient, through a unification process.

In detail, because the plurality of twisted liquid crystal layers 615 have characteristics of stimuli-responsive fluid, a transmission wavelength may be controlled in a wide range by adjusting an intensity of the electric field, and when the intensity of the applied electric field increases, the cone angle of the twisted liquid crystal complexes 612 in the plurality of twisted liquid crystal layers 615 may decrease whereby the inter-layer pitch becomes shorter and light of a short wavelength region may be reflected, and when the intensity of the applied electric field decreases, the cone angle of the twisted liquid crystal complexes 612 in the plurality of twisted liquid crystal layers 615 may increase whereby the inter-layer pitch becomes longer and light of a long wavelength region may be reflected.

In more detail, as illustrated in FIGS. 5A, 5B, and 5C, a first inter-layer pitch P₁ of the plurality of twisted liquid crystal layers 615 may be longest when a first electric field E₁, an intensity of which is weak, is applied, a third inter-layer pitch P₃ of the plurality of twisted liquid crystal layers 615 may be shortest when a third electric field E₃, an intensity of which is strong, is applied, and a second inter-layer pitch P₂ of the plurality of twisted liquid crystal layers 615 may be shorter than the first inter-layer pitch and longer than the third inter-layer pitch when a second electric field E₂, an intensity of which is stronger than that of the first electric field and weaker than that of the third electric field, is applied.

That is, when the layered twisted liquid crystal thin film 610 has the pseudo-layer that is formed by arranging the plurality of twisted liquid crystal layers 615 while the plurality of twisted liquid crystal layers 615 have the same inter-layer pitch with no inter-layer pitch gradient through a unification process, the pitches between the layers may be maintained to be the same, and the inter-layer pitches of the layers may be changed according to the intensity of the electric field.

Moreover, when the layered twisted liquid crystal thin film 610 has the pseudo-layer that is formed by arranging the plurality of twisted liquid crystal layers 615 while the plurality of twisted liquid crystal layers 615 have different inter-layer pitches and form an inter-layer pitch gradient, the inter-layer pitch gradient may be maintained and the inter-layer pitches of the layers may be changed according to the intensity of the electric field.

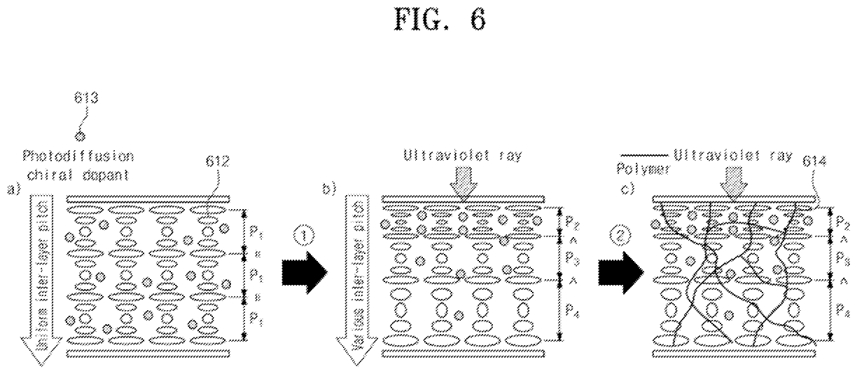

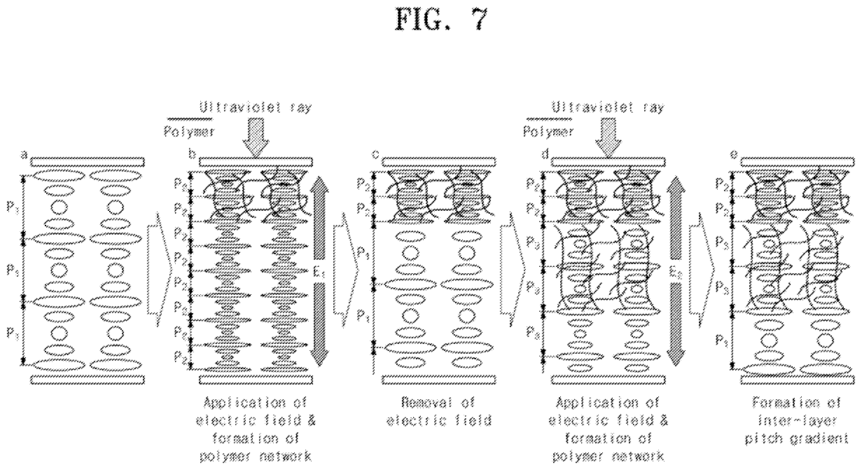

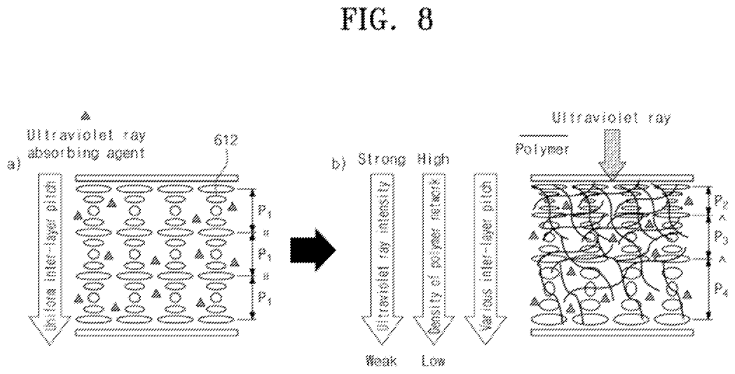

FIG. 6 is a view illustrating a process of forming an inter-layer pitch gradient by adjusting a concentration of the chiral dopant in the layered twisted liquid crystal thin film according to an embodiment of the present disclosure, FIG. 7 is a view illustrating a process of forming an inter-layer pitch gradient through a staged adjustment of electric fields of the layered twisted liquid crystal thin film according to another embodiment of the present disclosure, and FIG. 8 is a view illustrating a process of forming an inter-layer pitch gradient by adjusting a density of a polymer network of the layered twisted liquid crystal thin film according to another embodiment of the present disclosure.

FIG. 6A is a view illustrating a chiral dopant that is uniformly dispersed in the layered twisted liquid crystal thin film, FIG. 6B is a view illustrating a motion of the chiral dopant when an ultraviolet ray is irradiated to an upper end of the layered twisted liquid crystal thin film, and FIG. 6C is a view illustrating a state, in which the inter-layer pitch gradient formed in the layered twisted liquid crystal thin film is stabilized by the polymer network.

As illustrated in FIG. 6, in the transmissive tunable hyperspectral filter using the layered twisted liquid crystal thin film according to an embodiment of the present disclosure, the layered twisted liquid crystal thin film 610 may include the chiral dopant 613 having a property of being diffused to a side, on which an ultraviolet ray is irradiated, and the photopolymerizable polymer 614 that stabilizes the twisted liquid crystal complexes 612 on the pseudo-layer through an ultraviolet ray curing reaction, and the layered twisted liquid crystal thin film 610 may include the pseudo-layer that is formed by arranging the plurality of twisted liquid crystal layers 615 while the plurality of twisted liquid crystal layers 615 form an inter-layer pitch gradient by forming a concentration gradient of the chiral dopant in the layered twisted liquid crystal thin film 610 as, when an ultraviolet ray is irradiated to an upper end of the layered twisted liquid crystal thin film 610, the chiral dopant 613 is diffused toward the irradiated ultraviolet ray, and adjusting the concentration of the chiral dopant such that the inter-layer pitch of the twisted liquid crystal layer 615 located at an upper portion of the layered twisted liquid crystal thin film 610 becomes shorter and the inter-layer pitch of the twisted liquid crystal layer 615 located at a lower portion of the layered twisted liquid crystal thin film 610 becomes longer thereof due to the formed concentration gradient of the chiral dopant.

In detail, referring to FIG. 6A, the plurality of twisted liquid crystal layers 615 may be arranged while having the same initial inter-layer pitch P₁ through the unification process, and then, the plurality of twisted liquid crystal layers 615 have the same inter-layer pitch due to the uniformly dispersed chiral dopant 613.

When a concentration of the chiral dopant 613 in the twisted liquid crystal layers 615 increases, a twisting property of the twisted liquid crystal complexes 612 is enhanced whereby a shorter inter-layer pitch may be derived. Furthermore, the chiral dopant 613 has photo diffusion characteristics to tend to be diffused toward a side, on which the ultraviolet ray is strong, and as in FIG. 6B, when the ultraviolet ray is irradiated to an upper end of the layered twisted liquid crystal thin film 610, the uniformly dispersed chiral dopant 613 is disposed to an upper portion of the liquid crystal thin film. As a result, as the inter-layer pitches along the plurality of twisted liquid crystal layers 615 sequentially become longer from an upper side to a lower side of the liquid crystal thin film, the twisted liquid crystal layers 615 on the upper side of the liquid crystal thin film have a shorter inter-layer pitch P₂ and the twisted liquid crystal layers 615 on the lower side have an inter-layer pitch gradient having a longer inter-layer pitch P₄.

Thereafter, as illustrated in FIG. 6C, a wide wavelength region of the light that is input to one layered twisted liquid crystal thin film 610 may be reflected by maintaining the inter-layer pitch gradient formed through the ultraviolet ray by forming the polymer network based on the photopolymerizable polymer.

Accordingly, the inter-layer pitch gradient may be formed such that the twisted liquid crystal layers 615 located at the upper end of the liquid crystal thin film have the short inter-layer pitch P₂, the twisted liquid crystal layers 615 at a middle portion thereof have the inter-layer pitch P₃ that is longer than P₂, and the twisted liquid crystal layers 615 located at the lower end thereof have the long interlayer pitch P₄.

Here, wavelength regions of the ultraviolet ray for diffusing the chiral dopant 613 and the ultraviolet ray for curing the photopolymerizable polymer are different.

FIG. 7A is a view illustrating a liquid crystal thin film having an initial inter-layer pitch, FIG. 7B is a view illustrating a liquid crystal thin film that forms a polymer network after a first electric field is applied, FIG. 7C is a view illustrating a liquid crystal thin film, from which the electric field is removed, FIG. 7D is a view illustrating a liquid crystal thin film that forms a polymer network after a second electric field is applied, and FIG. 7E is a view illustrating a liquid crystal thin film, in which an inter-layer pitch gradient is formed.

Referring to FIG. 7, in the transmissive tunable hyperspectral filter using the layered twisted liquid crystal thin film according to the another embodiment of the present disclosure, the layered twisted liquid crystal thin film 610 may include a pseudo-layer that is formed by applying an electric field to the layered twisted liquid crystal thin film 610 and changing the cone angle of the twisted liquid crystal complexes 612 to change the inter-layer pitch over the plurality of twisted liquid crystal layers 615 and irradiating an ultraviolet ray to an upper end of the layered twisted liquid crystal thin film 610 to form a polymer network based on the photopolymerizable polymer 614 and thus stabilize the twisted liquid crystal layers 615 corresponding to a partial area of the layered twisted liquid crystal thin film 610, by forming the twisted liquid crystal layer composite including one or more twisted liquid crystal layers 615 having the same inter-layer pitch, by causing the plurality of twisted liquid crystal layers 615, other than the twisted liquid crystal layer composites formed by removing the applied electric field to return to have the initial inter-layer pitch, and by arranging the plurality of twisted liquid crystal layer composites while the plurality of twisted liquid crystal layer composites have an inter-layer pitch gradient through a staged adjustment of electric fields of repeating the above processes.

Referring to FIG. 7A, the layered twisted liquid crystal thin film 610 may include the plurality of twisted liquid crystal layers 615 having the same inter-layer pitch through the unification process, and the plurality of twisted liquid crystal layers 615 may be uniformly arranged while having the same inter-layer pitch due to the uniformly dispersed chiral dopant 613.

That is, the layered twisted liquid crystal thin film 610 includes a layered structure that is formed by arranging the plurality of twisted liquid crystal layers 615 while the plurality of twisted liquid crystal layers 615 have the initial inter-layer pitch P₁ through the unification process.

As illustrated in FIG. 7B, when the first electric field E₁ is applied to the layered twisted liquid crystal thin film 610, the cone angle of the twisted liquid crystal complexes 612 decrease whereby the plurality of twisted liquid crystal layers 615 are arranged while having the decreased inter-layer pitch P₂. Thereafter, the decreased inter-layer pitch P₂ is stabilized by irradiating an ultraviolet ray to an upper end area of the layered twisted liquid crystal thin film 610 in a state, in which the first electric field E₁ is applied, and forming a polymer network based on the photopolymerizable polymer 614 in the first twisted liquid crystal layer composite located at an upper portion thereof and having the inter-layer pitch of P₂.

Subsequently, as illustrated in FIG. 7C, when the first electric field E₁ is removed, the inter-layer pitch located at the upper area of the layered twisted liquid crystal thin film 610 having the polymer network is maintained at P₂, whereas the remaining area having no polymer network returns to the initial inter-layer pitch P₁ whereby a composite of the twisted liquid crystal layer including two (P₁, P₂) twisted liquid crystal layers 615 is formed.

Thereafter, when the second electric field E₂ is applied to the layered twisted liquid crystal thin film 610, the cone angle of the twisted liquid crystal complexes 612 in an area having no polymer network decreases whereby the inter-layer pitch decreases to P₃. Subsequently, the decreased inter-layer pitch P₃ is stabilized by irradiating an ultraviolet ray to the layered twisted liquid crystal thin film 610 to form a polymer network based on the photopolymerizable polymer 614 in the second twisted liquid crystal layer composite located at a middle area and having the inter-layer pitch of P₃.

Thereafter, when the second electric field E₂ is removed, the inter-layer pitch of the twisted liquid crystal layers 615 located at the upper end area of the layered twisted liquid crystal thin film 610 is maintained at P₂ and the inter-layer pitch of the twisted liquid crystal layers 615 located at the middle end area of the layered twisted liquid crystal thin film 610 is maintained at P₃, whereas the inter-layer pitch of the remaining areas having no polymer network return to the initial inter-layer pitch P₁ whereby a composite of the twisted liquid crystal layer including three (P₁, P₂, P₃) twisted liquid crystal layers 615 is formed.

Next, by repeating the method after an electric field of an intensity other than those of the first electric field and the second electric field is applied, the stabilized inter-layer pitch gradient may be formed in one layered twisted liquid crystal thin film 610.

FIG. 8A is a view illustrating an ultraviolet ray absorbing agent that is uniformly dispersed in the layered twisted liquid crystal thin film, and FIG. 8B is a view illustrating a density gradient of the polymer network when an ultraviolet ray is irradiated to an upper end of the layered twisted liquid crystal thin film.

As illustrated in FIG. 8, in the transmissive tunable hyperspectral filter using the layered twisted liquid crystal thin film according to the another embodiment of the present disclosure, the layered twisted liquid crystal thin film 610 may include the photopolymerizable polymer 614 that stabilizes by absorbing an ultraviolet ray to stabilize the twisted liquid crystal complexes 612 on the pseudo-layer through an ultraviolet ray curing reaction with the ultraviolet ray absorbing agent, and the layered twisted liquid crystal thin film 610 may include a pseudo-layer that is formed by decreasing an intensity of the ultraviolet ray and forming an ultraviolet ray intensity gradient in the layered twisted liquid crystal thin film 610 as the ultraviolet ray absorbing agent absorbs the ultraviolet ray when the ultraviolet ray is irradiated to the upper end of the layered twisted liquid crystal thin film 610, by forming a density gradient of the polymer network in the layered twisted liquid crystal thin film 610 due to the formed intensity gradient of the ultraviolet ray, and by arranging the plurality of twisted liquid crystal layers 615 while the plurality of twisted liquid crystal layers 615 form an inter-layer pitch gradient by adjusting a density of polymer network such that the inter-layer pitch of the twisted liquid crystal layers 615 located at an upper portion of the layered twisted liquid crystal thin film 610 becomes shorter and the inter-layer pitch of the twisted liquid crystal layers 615 located at a lower portion thereof becomes longer according to the formed density gradient of the polymer network.

It is preferable that the ultraviolet ray absorbing agent is at least one material selected from a group consisting of 2-(2-hydroxy-5-methylphenyl)benzotriazole and 2-(3,5-di-tert-butyl-2-hydroxyphenyl)-5-chlorobenzotriazole. Furthermore, any material that may absorb a wavelength region of the light, in which a curing reaction of the photopolymerizable polymer 614 is occurred, may be used as the ultraviolet ray absorbing agent without limitation.

In detail, referring to FIG. 8A, the layered twisted liquid crystal thin film 610 may include the plurality of twisted liquid crystal layers 615 having the same inter-layer pitch through the unification process, and then, the ultraviolet ray absorbing agent may be uniformly dispersed in the plurality of twisted liquid crystal layers 615. In addition, the layered twisted liquid crystal thin film 610 may further include the chiral dopant 613.

When the ultraviolet ray absorbing agent is dispersed in the twisted liquid crystal layer 615, an intensity of the ultraviolet ray may decrease exponentially, and the ultraviolet ray absorbing agent has light absorption characteristics.

As shown in FIG. 8B, when the ultraviolet ray is irradiated to an upper end of the layered twisted liquid crystal thin film 610, an intensity gradient of the ultraviolet ray is formed in the layered twisted liquid crystal thin film. As a result, because the intensity of the ultraviolet ray is strong at the upper end of the layered twisted liquid crystal thin film 610, a large amount of the photopolymerizable polymer 614 is cured whereby the density of the polymer network becomes higher, and because the intensity of the ultraviolet ray is weak at the lower end of the layered twisted liquid crystal thin film 610, a small amount of the photopolymerizable polymer 614 is cured whereby the density of the polymer network becomes lower.

In addition, because a shorter inter-layer pitch may be derived by increasing a twisting performance of the twisted liquid crystal complex 612 as the density of the polymer network is higher, the twisted liquid crystal layers 615 on an upper side of the liquid crystal thin film have a short inter-layer pitch P₂, and the twisted liquid crystal layers 615 on a lower side thereof have an inter-layer pitch gradient having a long inter-layer pitch P₄.

Here, the twisted liquid crystal layers 615 located at an upper end of the liquid crystal thin film may have the short inter-layer pitch P₂, the twisted liquid crystal layers 615 located at a middle portion thereof may have the inter-layer pitch P₃ that is longer than P₂, and the twisted liquid crystal layers 615 located at a lower end thereof may have the inter-layer pitch gradient having the inter-layer pitch P₄ that is longer than P₃.

That is, because the inter-layer pitch gradient may be formed and may be maintained as well by adjusting the density of the polymer network, a wide wavelength region may be reflected by one layered twisted liquid crystal thin film 610.

Accordingly, the transmissive wavelength tunable hyperspectral filter using the layered twisted liquid crystal thin film according to an embodiment of the present disclosure may selectively adjust a transmissive wavelength with one spectral filter by using the layered twisted liquid crystal thin film that is a new material.

Furthermore, light of a wavelength region, in which the reflection wavelengths do not overlap each other, may be transmitted by laminating two or more layered twisted liquid crystal thin films having different broadband reflection bandgaps, and thus, because the number of laminated liquid crystal thin films may be reduced, a high transmittance and a small FWHM of transmissive wavelength may be obtained.

Hereinafter, the present disclosure will be described in more detail through the embodiments. However, the following embodiments are examples for helping understand the present disclosure, and a scope of the present disclosure is not limited thereto.

### Embodiments 1 and 2: Manufacturing of Transmissive Wavelength Tunable Hyperspectral Filter Using Layered Twisted Liquid Crystal Thin Film

First, to manufacture a transmissive wavelength tunable hyperspectral filter using the layered twisted liquid crystal thin film of the present disclosure, two homogeneous liquid crystal thin films containing a liquid crystal composition, in which a twisted liquid crystal complex, a chiral dopant, and a photopolymerizable polymer are mixed, were prepared, and the twisted liquid crystal complex, the chiral dopant, and the photopolymerizable polymer were used in a weight ratio of 95:4:1 with respect to 100% by weight of the liquid crystal composition.

Then, the layered twisted liquid crystal thin film included at least 50 twisted liquid crystal layers, the inter-layer pitches of the respective layers were prepared to be constant, and a thickness of the liquid crystal thin film was set to 20 μm.

A first layered twisted liquid crystal thin film including a pseudo-layer that was formed by deriving a polymer network by irradiating an ultraviolet ray of a wavelength of 365 nm to the one layered homogeneous liquid crystal thin film by using an ultraviolet ray irradiator for an hour, and by arranging five twisted liquid crystal layer composites including one or more twisted liquid crystal layers having the same inter-layer pitch while the five twisted liquid crystal layer composites form an inter-layer pitch by applying electric fields to the liquid crystal thin film at 1.6, 1.5, 1.4, 1.3, and 1.2 V/μm for 10 minutes while the ultraviolet ray is irradiated was manufactured. Then, each of the twisted liquid crystal layer composites included at least 10 twisted liquid crystal layers such that layers, the number of which is large enough to reflect a specific wavelength, was made.

Thereafter, a second layered twisted liquid crystal thin film including a pseudo-layer that was formed by arranging five twisted liquid crystal layer composites including one or more twisted liquid crystal layers having the same inter-layer pitch while the five twisted liquid crystal layer form an inter-layer pitch gradient by applying electric fields at 1.0, 0.9, 0.8, 0.7, and 0.6 V/μm while the same method as the above one was used for the another layered homogeneous liquid crystal thin film was manufactured.

Here, the first layered twisted liquid crystal thin film had a broadband reflection bandgap of a short wavelength region, the second layered twisted liquid crystal thin film was a thin film having a broadband reflection bandgap of a long wavelength region, and the reflection wavelength regions of the two liquid crystal thin films were made not to overlap each other.

Thereafter, a transmissive wavelength tunable hyperspectral filter was manufactured by laminating the first layered twisted liquid crystal thin film and the second layered twisted liquid crystal thin film (embodiment 1).

In addition to the above method, a third layered twisted liquid crystal thin film including a pseudo-layer that was formed by irradiating a 365 nm ultraviolet ray for one hour while a chiral dopant that was diffused in a direction, in which the ultraviolet ray was irradiated, was utilized, and by arranging ten twisted liquid crystal layers while the ten twisted liquid crystal layers form an inter-layer pitch gradient due to a concentration difference between the chiral dopant on the upper and lower sides.

### Embodiment 3: Manufacturing of Transmissive Wavelength Tunable Hyperspectral Filter Using Layered Twisted Liquid Crystal Thin Film

To manufacture a transmissive wavelength tunable hyperspectral filter using layered twisted liquid crystal thin film according to the present disclosure, two layered twisted liquid crystal thin films including a liquid crystal composite, in which a twisted liquid crystal complex, a chiral dopant, a photopolymerizable polymer, and an ultraviolet ray absorbing agent are mixed, were prepared. Then, with respect to 100% by weight of the liquid crystal composition, the liquid crystal composite, the chiral dopant, the photopolymerizable polymer, and the ultraviolet ray absorber were constituted in a weight ratio of 86.2:5.0:8.0:0.8, respectively.

Then, the layered twisted liquid crystal thin film included at least 125 twisted liquid crystal layers of the same inter-layer pitch, and a thickness of the liquid crystal thin film was set to 50 M.

Thereafter, a polymer network density gradient in the liquid crystal thin film was formed by irradiating an ultraviolet ray of a wavelength of 365 nm for 30 minutes by using an ultraviolet ray irradiator in a state, in which an electric field was applied to one layered twisted liquid crystal thin film at 1.50 μm. A fourth layered twisted liquid crystal thin film including a pseudo-layer that was formed by arranging a plurality of twisted liquid crystal layers 615 while the plurality of twisted liquid crystal layers 615 form an inter-layer pitch gradient due to formation of a density gradient of a polymer network was manufactured.

Thereafter, a density gradient of a polymer network in the liquid crystal thin film was formed by irradiating an ultraviolet ray of a wavelength of 365 nm for 30 minutes by using an ultraviolet ray irradiator in a state, in which an electric field is applied to another layered twisted liquid crystal thin film at 1.70 μm. A fifth layered twisted liquid crystal thin film including a pseudo-layer that was formed by arranging the plurality of twisted liquid crystal layers 615 while the plurality of twisted liquid crystal layers 615 form an inter-layer pitch gradient due to the formation of the density gradient of the polymer network.

Here, the fourth layered twisted liquid crystal thin film had a broadband reflection bandgap of a long wavelength region, the fifth layered twisted liquid crystal thin film was a thin film having a broadband reflection bandgap of a short wavelength region, and the reflection wavelength regions of the two liquid crystal thin films were made not to overlap each other.

Thereafter, a transmissive wavelength tunable hyperspectral filter was manufactured by laminating the fourth layered twisted liquid crystal thin film and the fifth layered twisted liquid crystal thin film was manufactured (embodiment 3).

### Comparative Example 1: Manufacturing of Transmissive Wavelength Tunable Hyperspectral Filter Using Layered Twisted Liquid Crystal Thin Film

To manufacture a transmissive wavelength tunable hyperspectral filter using layered twisted liquid crystal thin film according to the present disclosure, one layered twisted liquid crystal thin film including a liquid crystal composite, in which a twisted liquid crystal complex, a chiral dopant, a photopolymerizable polymer, and an ultraviolet ray absorbing agent are mixed, were prepared. Then, with respect to 100% by weight of the liquid crystal composition, the liquid crystal composite, the chiral dopant, the photopolymerizable polymer, and the ultraviolet ray absorbing agent were constituted in a weight ratio of 86.2:5.0:8.0:0.8, respectively.

Then, the layered twisted liquid crystal thin film included at least 125 twisted liquid crystal layers of the same inter-layer pitch, and a thickness of the liquid crystal thin film was set to 50 M.

Thereafter, a sixth layered twisted liquid crystal thin film including a pseudo-layer that was formed by arranging one or more twisted liquid crystal layers having the same inter-layer pitch through a unification process by applying an electric field to the layered twisted liquid crystal thin film at 1.50 V/μm was manufactured (comparative example 1).

### Experimental Example 1: Evaluation of Characteristics of Broadband Reflection Bandgaps

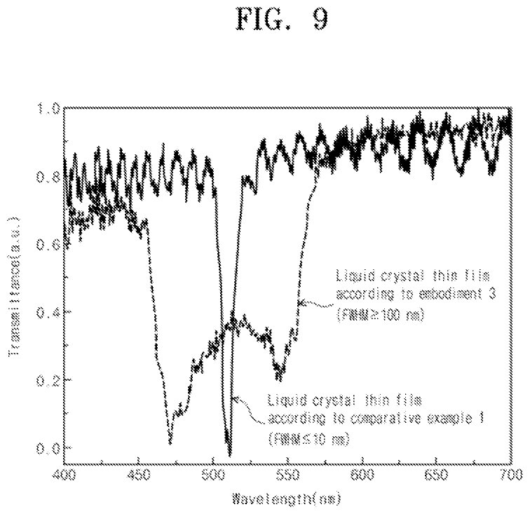

Characteristics of reflection bandgaps of the fourth layered twisted liquid crystal thin film according to embodiment 3 and the sixth layered twisted liquid crystal thin film according to comparative example 1 were evaluated, and the result are illustrated in FIG. 9.

FIG. 9 illustrates a precedent result for identifying formation of a broadband reflection bandgap of the layered twisted liquid crystal thin film according to the third embodiment.

As illustrated in FIG. 9, it was identified that the fourth layered twisted liquid crystal thin film according to embodiment 3 could form the broad reflection bandgap only with one liquid crystal thin film due to the inter-layer pitch gradient.

In detail, it was identified that an FWHM of the reflection bandgap of the fourth layered twisted liquid crystal thin film according to embodiment 3 was measured to be 100 nm or more and this was about 10 times or more of an FWHM of a reflection bandgap of the sixth layered twisted liquid crystal thin film according to comparative example 1.

### Experimental Example 2: Analysis of Transmissive Wavelength

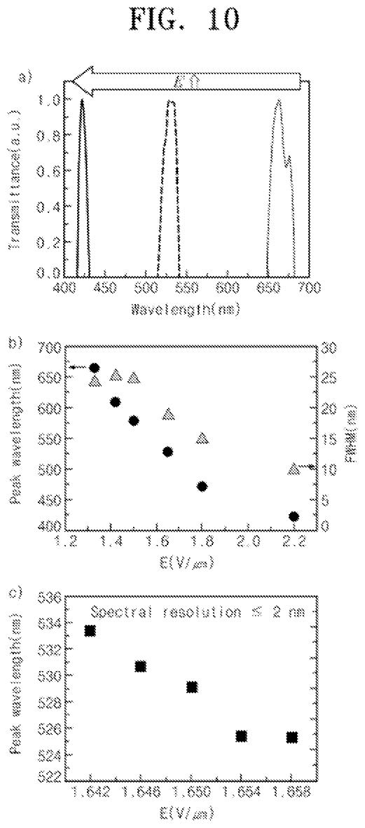

To discuss evaluation of characteristics of a transmissive wavelength of the transmissive wavelength tunable hyperspectral filter according to embodiment 3, a wavelength region that is transmitted was analyzed while changing an intensity of an electric field in embodiment 3, and the result was illustrated in FIG. 10.

FIG. 10 illustrates a precedent result of adjustment of a transmissive wavelength through adjustment of an intensity of an electric field in the transmissive wavelength tunable hyperspectral filter using the layered twisted liquid crystal thin film according to the third embodiment.

FIG. 10A is a graph depicting a transmissive wavelength adjustment range and a transmittance according to an intensity of an electric field, FIG. 10B illustrates a result illustrating a transmissive peak wavelength and an FWHM according to an intensity of an electric field, and FIG. 10C illustrates a spectral resolution of a transmissive peak wavelength according to an intensity of an electric field.

As illustrated in FIG. 10, it was identified that a transmissive wavelength region was changed as the intensity of the electric field is adjusted, and it may be identified that a transmissive wavelength having a high transmittance and narrow FWHM may be obtained.

In detail, it may be identified that the transmissive wavelength of embodiment 3 had a FWHM that is smaller than 25 nm, and it was identified that the spectral resolution was 2 nm or less.

### Experimental Example 3: Analysis of Transmissive Wavelength

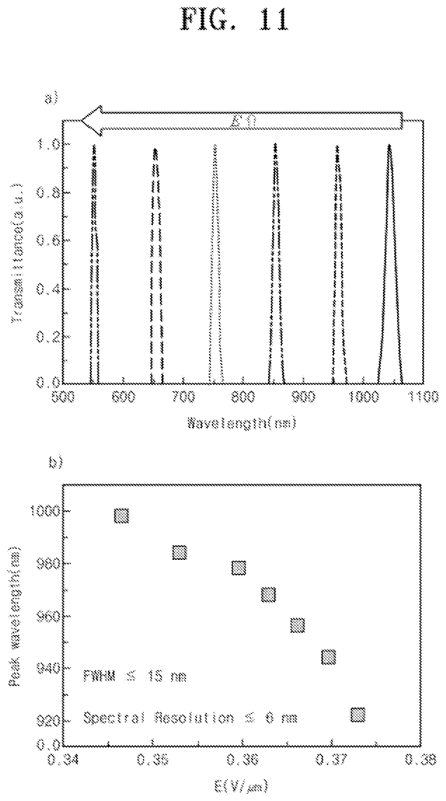

To discuss evaluation of characteristics of a transmissive wavelength of the transmissive wavelength tunable hyperspectral filter according to embodiment 1, a wavelength region that is transmitted was analyzed while changing an intensity of an electric field in embodiment 1, and the result was illustrated in FIG. 11.

FIG. 11 is a precedent result of adjustment of a transmissive wavelength through adjustment of an intensity of an electric field in the transmissive wavelength tunable hyperspectral filter using the layered twisted liquid crystal thin film according to a first embodiment.

FIG. 11A is a graph depicting a transmissive wavelength adjustment range and a transmittance according to an intensity of an electric field, and FIG. 11B illustrates a spectral resolution of a transmissive peak wavelength according to an intensity of an electric field.

As illustrated in FIG. 11, it was identified that a transmissive wavelength region was changed as the intensity of the electric field is adjusted, and it may be identified that a transmissive wavelength having a high transmittance and narrow FWHM may be obtained.

In detail, it may be identified that the transmissive wavelength of embodiment 1 had a FWHM that is smaller than 15 nm, and it was identified that the spectral resolution was 6 nm or less.

According to the transmissive wavelength tunable hyperspectral filters using a layered twisted liquid crystal thin film according to the embodiments of the present disclosure, a transmissive wavelength may be selectively adjusted with one spectral filter including a layered twisted liquid crystal that is a new material.

Although the transmissive wavelength tunable hyperspectral filters using a layered twisted liquid crystal thin film according to the embodiments of the present disclosure have been described with detailed embodiment forms until now, they are simply examples, and the present disclosure is not limited thereto and should be construed as having a widest range that follows basic spirits disclosed in the specification. An ordinary person in the art may carry out patterns having unmentioned shapes by combining or replacing the disclosed embodiment forms, but they also do not deviate from the scope of the present disclosure. In addition, it is apparent that an ordinary person in the art may easily change or modify the disclosed embodiment forms based on the specification, and the changes or modifications also pertain to the scope of the present disclosure.

What is claimed is:

1. A transmissive wavelength tunable hyperspectral filter using layered twisted liquid crystal thin film, wherein
the transmissive wavelength tunable hyperspectral filter is formed by laminating two or more layered twisted liquid crystal thin films having different broadband reflection bandgaps,
wherein each of the layered twisted liquid crystal thin films includes:
a twisted liquid crystal layer including a plurality of unit liquid crystal molecules, and formed by arranging twisted liquid crystal complexes defining a preset cone angle along the helical axis with respect to the helical axis, and
a pseudo-layer formed by arranging a plurality of twisted liquid crystal layers in a lengthwise direction of the helical axis at a preset inter-layer pitch (P).

2. The transmissive wavelength tunable hyperspectral filter of claim 1,
wherein the layered twisted liquid crystal thin film selectively reflects, among the incident lights, only light of a specific wavelength region through Bragg reflection,
wherein the specific wavelength region is set based on an average refractive index (n̅) of the layered twisted liquid crystal thin film and an inter-layer pitch (P) of a twisted liquid crystal layer included in the corresponding layered twisted liquid crystal thin film to satisfy an equation below, and
wherein the inter-layer pitch (P) of the twisted liquid crystal layer is determined by the cone angle of the twisted liquid crystal complex:
here, n̅ is the average refractive index of the layered twisted liquid crystal thin film, and P is the inter-layer pitch of the twisted liquid crystal.

3. The transmissive wavelength tunable hyperspectral filter of claim 2, wherein a broadband reflection bandgap of the layered twisted liquid crystal thin film is shifted by a change in the inter-layer pitch of the twisted liquid crystal layer through application of external stimuli, and
wherein the layered twisted liquid crystal thin film transmits only light of a wavelength region corresponding to the shifted broadband reflection bandgap.

4. The transmissive wavelength tunable hyperspectral filter of claim 3, wherein the external stimulus is any one stimulus selected from a group consisting of an electric field, temperature, moisture, bacteria, and light.

5. The transmissive wavelength tunable hyperspectral filter of claim 4, wherein a liquid crystal thin film of any one layer of the two or more layered twisted liquid crystal thin films and a liquid crystal thin film of another layer thereof have different shifted broadband reflection bandgaps, when the external stimulus is applied.

6. The transmissive wavelength tunable hyperspectral filter of claim 5, wherein the pseudo-layer is formed by arranging a plurality of twisted liquid crystal layers arranged in an interior of the layered twisted liquid crystal thin film such that the plurality of twisted liquid crystal layers form an inter-layer pitch gradient.

7. The transmissive wavelength tunable hyperspectral filter of claim 6, wherein the pseudo-layer is formed by arranging a plurality of twisted liquid crystal layer composites including one or more twisted liquid crystal layers having the same inter-layer pitch such that the plurality of twisted liquid crystal layer composites form an inter-layer pitch gradient.

8. The transmissive wavelength tunable hyperspectral filter of claim 7, wherein the layered twisted liquid crystal thin film includes:
a chiral dopant having a property of being diffused toward a side, on which ultraviolet rays are irradiated; and
a photopolymerizable polymer fixing the twisted liquid crystal complexes on the pseudo-layer through an ultraviolet ray curing reaction, and
wherein a concentration gradient in the chiral dopant in the layered twisted liquid crystal thin film is formed as the chiral dopant is diffused toward the irradiated ultraviolet rays when the ultraviolet rays are irradiated to an upper end of the layered twisted liquid crystal thin film, and
wherein the layered twisted liquid crystal thin film includes a pseudo-layer formed as the plurality of twisted liquid crystal layers are arranged while forming an inter-layer pitch gradient by adjusting a concentration of the chiral dopant such that an inter-layer pitch of a twisted liquid crystal layer located on an upper portion of the layered twisted liquid crystal thin film becomes shorter and an inter-layer pitch of a twisted liquid crystal layer located at a lower portion thereof becomes longer according to the concentration gradient of the formed chiral dopant.

9. The transmissive wavelength tunable hyperspectral filter of claim 8, wherein the layered twisted liquid crystal thin film changes the inter-layer pitch over the plurality of twisted liquid crystal layers by applying the electric field to the layered twisted liquid crystal thin film and changing the cone angle of the twisted liquid crystal complex,
wherein the layered twisted liquid crystal thin film forms a twisted liquid crystal layer composite including one or more twisted liquid crystal layers having the same inter-layer pitch by irradiating the ultraviolet rays to an upper end of the layered twisted liquid crystal thin film, forming a polymer network based on the photopolymerizable polymer, and stabilizing the twisted liquid crystal layer corresponding to a partial area of the layered twisted liquid crystal thin film,
wherein some of the plurality of twisted liquid crystal layers, other than the formed twisted liquid crystal layer composites, are caused to return to have an initial inter-layer pitch by removing the applied electric field, and
wherein layered twisted liquid crystal thin film includes a pseudo-layer formed by arranging the plurality of twisted liquid crystal layer composites while the plurality of twisted liquid crystal layer composites form an inter-layer pitch gradient, through a staged adjustment of electric fields, in which these processes are repeated.
